(19) United States
(12) Patent Application Publication
(10) Pub. No.: US 2010/0033420 A1
(43) Pub. Date: Feb. 11, 2010

(54) LIGHTING SYSTEM HAVING CONTROL ARCHITECTURE

(76) Inventor: Kun-Huang Jheng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/210,213

(22) Filed: Sep. 14, 2008

(30) Foreign Application Priority Data
Aug. 6, 2008 (TW) 097129880

(51) Int. Cl. G09G 3/36

(52) U.S. Cl. 345/102

(57) ABSTRACT

A lighting system having control architecture is disclosed for avoiding redundant lighting. The lighting system includes a switch, a pulse filter, a driving circuit, a lighting module, a light feedback module, a compensator, and a pulse width modulation (PWM) signal generator. The switch controls the transmission of a PWM signal to the driving circuit based on an enable control signal. The driving circuit generates a driving voltage for driving the lighting module to emit a light output based on the PWM signal. The light feedback module detects the light output for generating a feedback signal. The compensator provides a compensation signal to the PWM signal generator for generating the PWM signal based on the feedback signal and a reference signal. When the switch is turned off by the enable control signal, the pulse filter is utilized for filtering out periodical pulses caused by the equivalent capacitor of the switch.

### BACKGROUND OF THE INVENTION

1. Field of the Invention

The present invention relates to a lighting system, and more particularly, to a lighting system having control architecture for avoiding redundant lighting.

2. Description of the Prior Art

Because light emitting diodes (LEDs) are characterized by long lifetime, small size, low power consumption and high-bright lighting capability, LEDs have been widely applied in a variety of indication applications, indoor or outdoor lighting applications, traffic lights, vehicle auxiliary lighting applications, camera flashlights, and so forth. Besides, due to the successful commercialization of the white light-emitting diode (WLED), the backlight sources of liquid crystal displays (LCDs) are switched from traditional cold cathode fluorescent lamps (CCFLs) or external electrode fluorescent lamps (EEFLs) to LED lighting modules. While an LED lighting module is put in use as the backlight source of an LCD, a light-output control mechanism of the LED lighting module is required to provide an accurate light output so that the LCD is capable of achieving a high-quality image display.

Please refer to FIG. 1, which is a schematic diagram showing a prior-art lighting system 100 having control architecture. As shown in FIG. 1, the lighting system 100 comprises a plurality of resistors 110-115, a plurality of capacitors 120-121, a driving circuit 150, a lighting module 160, an operational amplifier 130, and a transistor 135. The resistors 110-114 in conjunction with the capacitors 120-121 are utilized for performing low-pass filtering and voltage dividing operations so as to generate a driving current control voltage Vx based on a pulse width modulation (PWM) signal S_{PWM} and an enable control signal S_{EN}. The resistor 110 and the resistor 111 are further utilized for performing a voltage dividing operation on the pulse width modulation signal S_{PWM} and the enable control signal S_{EN} for generating a driving control signal Sdrc. In general, the driving circuit 150 comprises a voltage boost unit 155 for generating a driving voltage Vdr by boosting a supply voltage Vcc based on the driving control signal Sdrc. The operational amplifier 130, the transistor 135 and the resistor 115 are coupled to form a current control circuit for generating a driving current Id based on the driving current control voltage Vx and the driving voltage Vdr. The lighting module 160 is then able to generate a light output based on the driving current Id.

Please refer to FIG. 2, which presents a truth table 200 of the enable control signal, the PWM signal and the driving control signal regarding the operation of the lighting system in FIG. 1, wherein H represents a high-level signal and L represents a low-level signal. As illustrated in the truth table 200, when both the enable control signal S_{EN} and the PWM signal S_{PWM} are high-level signals H, the driving control signal Sdrc is set to be a high-level signal H. When both the enable control signal S_{EN} and the PWM signal S_{PWM} are low-level signals L, the driving control signal Sdrc is set to be a low-level signal L. When the enable control signal S_{EN} is floated, the driving control signal Sdrc is conformed to the PWM signal S_{PWM}. When the driving control signal Sdrc is a high-level signal H, the voltage boost unit 155 is enabled for boosting the supply voltage Vcc so as to generate the driving voltage Vdr having high voltage for driving the lighting module 160 to emit light. When the driving control signal Sdrc is a low-level signal L, the voltage boost unit 155 is disabled, and the lighting module 160 quits lighting due to the driving voltage Vdr having low voltage. That is, the average intensity of the light output generated by the lighting module 160 can be adjusted based on the duty cycle of the PWM signal S_{PWM}.

However, when the enable control signal S_{EN} is a high-level signal H and the PWM signal S_{PWM} is a low-level signal L, due to the voltage dividing operation of the resistors 110 and 111, the driving control signal Sdrc is set to be a quasi low-level signal Lx1 instead of an ideal low-level signal L. Similarly, when the enable control signal S_{EN} is a low-level signal L and the PWM signal S_{PWM} is a high-level signal H, due to the voltage dividing operation of the resistors 110 and 111, the driving control signal Sdrc is set to be a quasi low-level signal Lx2 instead of an ideal low-level signal L. The quasi low-level signals Lx1 and Lx2 cannot completely disable the voltage boosting operation of the voltage boost unit 155, which results in unwanted redundant lighting of the lighting module 160. Accordingly, the lighting system 100 is not able to provide an accurate control of the light output for an LCD to achieve a high-quality image display.

### SUMMARY OF THE INVENTION

In accordance with an embodiment of the present invention, a lighting system having control architecture is disclosed for providing an accurate light-output control by avoiding redundant lighting. The lighting system comprises a switch, a first resistor, a second resistor, a pulse filter, a driving circuit, and a lighting module.

The switch comprises a first end for receiving a pulse width modulation (PWM) signal, a control end for receiving an enable control signal, and a second end for outputting a driving control signal. The first resistor comprises a first end for receiving a supply voltage and a second end coupled to the control end of the switch. The pulse filter comprises a first end coupled to the second end of the switch and a second end coupled to a ground. The second resistor comprises a first end coupled to the lighting module and a second end coupled to the ground. The driving circuit is utilized for generating a driving voltage based on the supply voltage and the driving control signal. Furthermore, the driving circuit functions to generate a driving current control voltage based on the driving control signal. The driving circuit comprises a power end for receiving the supply voltage, an input end coupled to the second end of the switch for receiving the driving control signal, a first output end coupled to the lighting module for outputting the driving voltage, and a second output end coupled to the first end of the second resistor for outputting the driving current control voltage. The lighting module is coupled to both the driving circuit and the second resistor and functions to generate a light output based on the driving voltage and the driving current control voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a prior-art lighting system having control architecture.

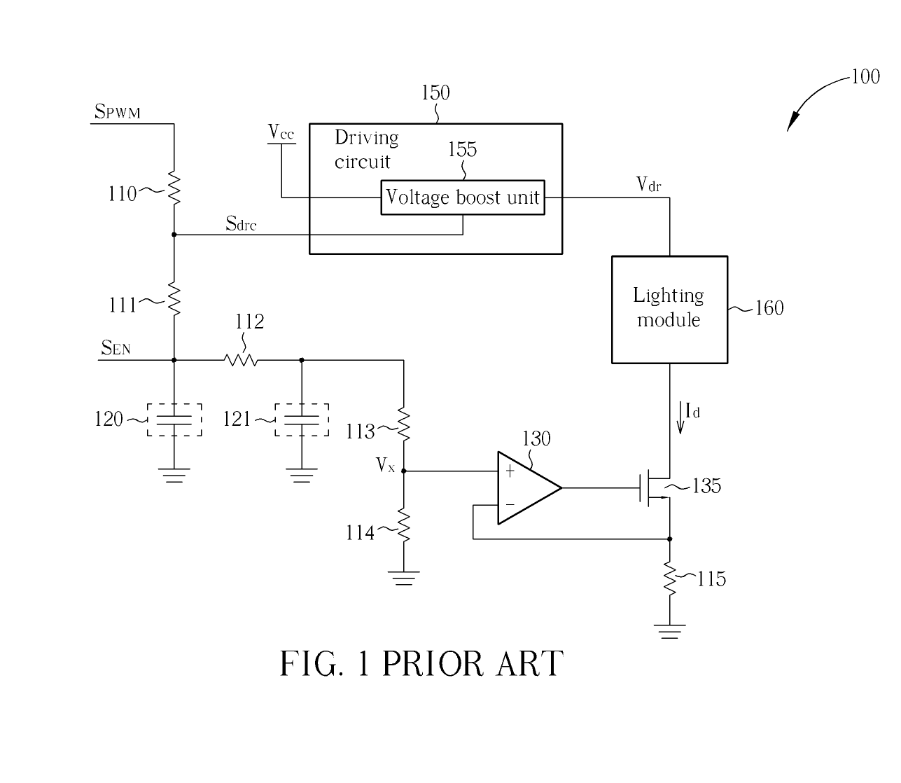

FIG. 2 presents a truth table of the enable control signal, the PWM signal and the driving control signal regarding the operation of the lighting system in FIG. 1.

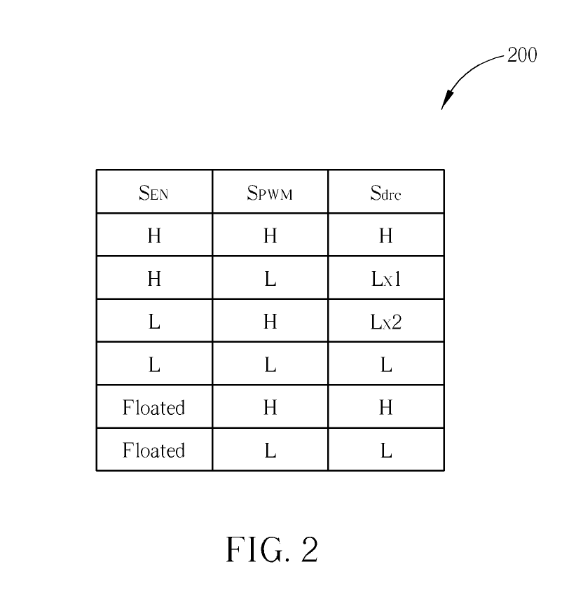

FIG. 3 is a schematic diagram showing a lighting system having control architecture in accordance with a first embodiment of the present invention.

FIG. 4 presents a truth table of the enable control signal, the PWM signal and the driving control signal regarding the operation of the lighting system in FIG. 3.

FIG. 5 is a schematic diagram showing a lighting system having control architecture in accordance with a second embodiment of the present invention.

FIG. 6 is a schematic diagram showing a lighting system having control architecture in accordance with a third embodiment of the present invention.

FIG. 7 is a schematic diagram showing a lighting system having control architecture in accordance with a fourth embodiment of the present invention.

### DETAILED DESCRIPTION

Hereinafter, preferred embodiments of the present invention will be described in detail with reference to the accompanying drawings. Here, it is to be noted that the present invention is not limited thereto.

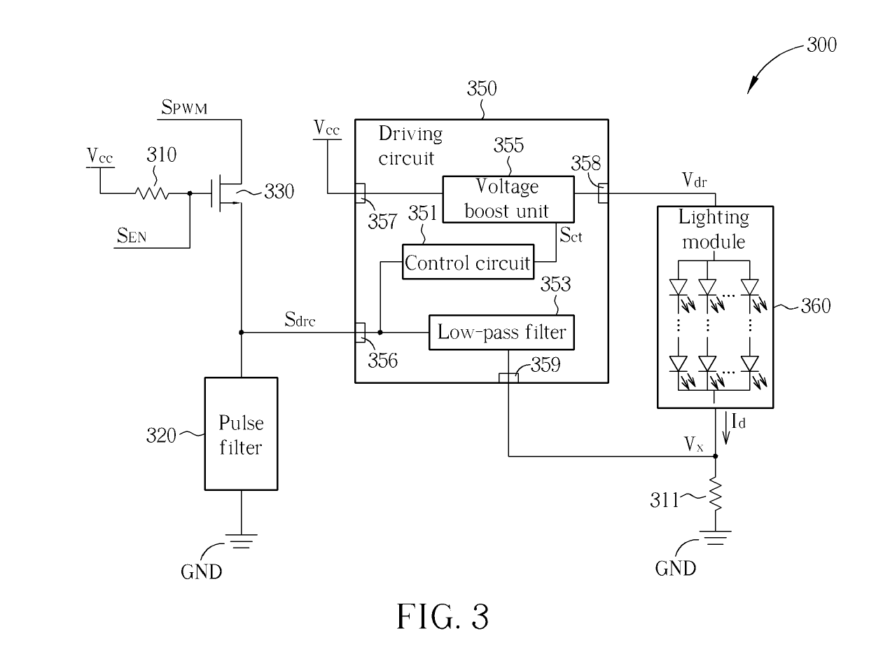

Please refer to FIG. 3, which is a schematic diagram showing a lighting system 300 having control architecture in accordance with a first embodiment of the present invention. As shown in FIG. 3, the lighting system 300 comprises a switch 330, a first resistor 310, a pulse filter 320, a driving circuit 350, a lighting module 360, and a second resistor 311. The switch 330 is a metal oxide semiconductor (MOS) field effect transistor or a junction field effect transistor (OFET). The lighting module 360 comprises an LED unit or a plurality of parallel-connected LED units. Each LED unit comprises an LED or a plurality of series-connected LEDs. The pulse filter 320 is a varistor, a transient voltage suppressor (TVS), or a high-pass filter. In an embodiment, the pulse filter 320 is a high-pass filter having only one capacitor.

The switch 330 comprises a first end for receiving a PWM signal S_{PWM}, a control end for receiving an enable control signal S_{EN}, and a second end for outputting a driving control signal Sdrc. The first resistor 310 comprises a first end for receiving a supply voltage Vcc and a second end coupled to the control end of the switch 330. The pulse filter 320 comprises a first end coupled to the second end of the switch 330 and a second end coupled to a ground GND. The driving circuit 350 comprises an input end 356, a power end 357, a first output end 358, a second output end 359, a voltage boost unit 355, a control circuit 351, and a low-pass filter 353. The power end 357 is utilized for receiving the supply voltage Vcc. The input end 356 is coupled to the second end of the switch 330 for receiving the driving control signal Sdrc. The first output end 358 is utilized for outputting a driving voltage Vdr. The second output end 359 is utilized for outputting a driving current control voltage Vx. The driving circuit 350 is utilized for generating the driving voltage Vdr based on the supply voltage Vcc and the driving control signal Sdrc. Furthermore, the driving circuit 350 functions to generate the driving current control voltage Vx based on the driving control signal Sdrc. The second resistor 311 comprises a first end coupled to the second output end 359 of the driving circuit 350 for receiving the driving current control voltage Vx and a second end coupled to the ground GND. The first end of the second resistor 311 is further coupled to the lighting module 360. The lighting module 360 in conjunction with the second resistor 311 generates a driving current Id based on the driving voltage Vdr and the driving current control voltage Vx, and therefore the lighting module 360 can be driven to emit a light output by the driving current Id.

The control circuit 351 is coupled between the input end 356 and the voltage boost unit 355 of the driving circuit 350. The control circuit 351 is utilized to generate a control signal Sct by compensating the driving control signal Sdrc with the turn-on voltage drop of the switch 330. In one embodiment, if the switch 330 is an N-type MOS field effect transistor, the turn-on voltage drop of the switch 330 is the drain-source voltage drop of the N-type MOS field effect transistor turned on. The voltage boost unit 355 is coupled to the power end 357, the control circuit 351 and the first output end 358 of the driving circuit 350. The voltage boost unit 355 functions to generate the driving voltage Vdr by boosting the supply voltage Vcc based on the control signal Sct. The low-pass filter 353 is coupled between the input end 356 and the second output end 359 of the driving circuit 350. The low-pass filter 353 performs a low-pass filtering operation on the driving control signal Sdrc for generating the driving current control voltage Vx. In another embodiment, the control circuit 351 can be omitted, and the voltage boost unit 355 is directly coupled to the input end 356 of the driving circuit 350 for receiving the driving control signal Sdrc. That is, the voltage boost unit 355 generates the driving voltage Vdr by boosting the supply voltage Vcc directly based on the driving control signal Sdrc.

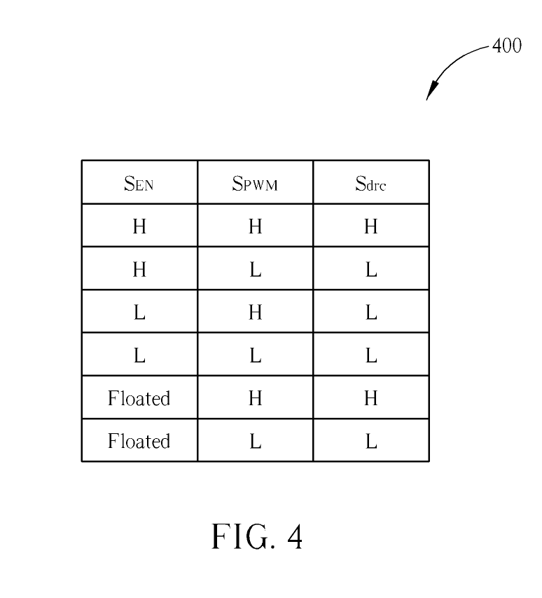

Please refer to FIG. 4, which presents a truth table 400 of the enable control signal, the PWM signal and the driving control signal regarding the operation of the lighting system in FIG. 3, wherein H represents a high-level signal and L represents a low-level signal. As illustrated in the truth table 400, when the enable control signal S_{EN} is a high-level signal H, the switch 330 is turned on for outputting the PWM signal S_{PWM} to become the driving control signal Sdrc. In view of that, the driving control signal Sdrc is conformed to the PWM signal S_{PWM}. That is, the driving control signal Sdrc is a high-level signal H when the PWM signal S_{PWM} is a high-level signal H, or alternatively the driving control signal Sdrc is a low-level signal L when the PWM signal S_{PWM} is a low-level signal L. Because of the turn-on voltage drop of the switch 330, the high-level voltage of the driving control signal Sdrc is less than that of the PWM signal S_{PWM} by the turn-on voltage drop of the switch 330. However, in general, the high-level voltage of the driving control signal Sdrc is still high enough to enable the voltage boost unit 355 for boosting the supply voltage Vcc, and the control circuit 351 may be omitted without degrading the performance of the lighting system 300. When the enable control signal S_{EN} is floated, the supply voltage Vcc can be furnished to the control end of the switch 330 via the first resistor, and therefore the switch 330 is turned on so that the driving control signal Sdrc is also conformed to the PWM signal S_{PWM}. Similarly, the high-level voltage of the driving control signal Sdrc is still less than that of the PWM signal S_{PWM} by the turn-on voltage drop of the switch 330.

When the enable control signal S_{EN} is a low-level signal L, the switch 330 is turned off so that the PWM signal S_{PWM} cannot be forwarded to the second end of the switch 330, and the driving control signal Sdrc is retained to be a low-level signal L. However, due to the effect of an equivalent capacitor between the first and second ends of the switch 330 on the PWM signal S_{PWM}, a periodical pulse noise will occur to the second end of the switch 330, and the periodical pulse noise is likely to result in redundant lighting of the lighting module 360. In other words, an unwanted light output may be generated by the periodical pulse noise. For solving the problem of redundant lighting caused by the periodical pulse noise, the pulse filter 320 is installed to get rid of the periodical pulse noise. That is, in the operation of the lighting system 300, the driving control signal Sdrc is generated without the quasi low-level signal and the periodical pulse noise so that the problem of redundant lighting can be solved completely, and therefore the lighting system 300 is able to provide an accurate control of the light output.

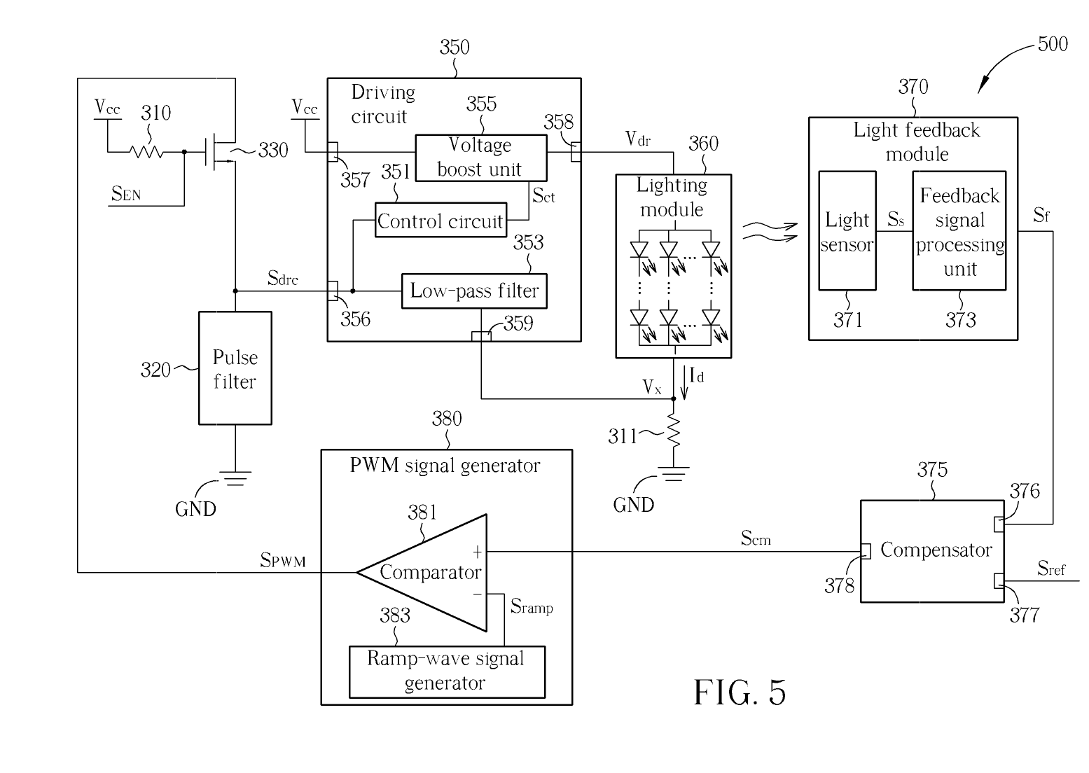

Please refer to FIG. 5, which is a schematic diagram showing a lighting system 500 having control architecture in accordance with a second embodiment of the present invention. As shown in FIG. 5, the lighting system 500 comprises a switch 330, a first resistor 310, a pulse filter 320, a driving circuit 350, a lighting module 360, a second resistor 311, a light feedback module 370, a compensator 375, and a PWM signal generator 380. The coupling relationships and related functionalities regarding the switch 330, the first resistor 310, the pulse filter 320, the driving circuit 350, the lighting module 360 and the second resistor 311 are similar to the above description on the lighting system 300. Consequently, in the operation of the lighting system 500, the truth table of the enable control signal S_{EN}, the PWM signal S_{PWM} and the driving control signal Sdrc is the same as the truth table 400 in FIG. 4. The light feedback module 370 is utilized for generating a feedback signal Sf based on the light output of the lighting module 360. The light feedback module 370 comprises a light sensor 371 and a feedback signal processing unit 373. The light sensor 371 senses the light output of the lighting module 360 for generating a light sensing signal Ss, and the feedback signal processing unit 373 performs a signal processing operation on the light sensing signal Ss for generating the feedback signal Sf.

The compensator 375 is coupled between the light feedback module 370 and the PWM signal generator 380 and functions to generate a compensation signal Scm based on the feedback signal Sf and a reference signal Sref. The compensator 375 comprises a first input end 376 coupled to the light feedback module 370 for receiving the feedback signal Sf, a second input end 377 for receiving the reference signal Sref, and an output end 378 for outputting the compensation signal Scm. The PWM signal generator 380 is coupled between the compensator 375 and the switch 330 and functions to generate the PWM signal S_{PWM} based on the compensation signal Scm. The PWM signal generator 380 comprises a comparator 381 and a ramp-wave signal generator 383. The ramp-wave signal generator 383 is used for generating a ramp-wave signal Sramp. The ramp-wave signal Sramp is a triangular-wave signal or a sawtooth-wave signal. The comparator 381 can be an operational amplifier for generating the PWM signal S_{PWM} by comparing the ramp-wave signal Sramp with the compensation signal Scm. The comparator 381 comprises a first input end coupled to the output end 378 of the compensator 375 for receiving the compensation signal Scm, a second input end coupled to the ramp-wave signal generator 383 for receiving the ramp-wave signal Sramp, and an output end for outputting the PWM signal S_{PWM} to the first end of the switch 330. In the embodiment shown in FIG. 5, the first and second input ends of the comparator 381 are the positive and negative input ends respectively.

It is noted that the lighting system 500 is a feedback control system, the enable control signal S_{EN} is utilized for enabling/disabling the light output of the lighting module 360, and the reference signal Sref is utilized for controlling the intensity of the light output. When the enable control signal S_{EN} enables the light output of the lighting module 360, the light feedback module 370 senses the light output for generating the feedback signal Sf. If the feedback signal Sf is less than the reference signal Sref, the compensator 375 raises the compensation signal Scm so that the intensity of the light output can be increased through increasing the duty cycle of the PWM signal S_{PWM} by the PWM signal generator 380. On the other hand, if the feedback signal Sf is greater than the reference signal Sref, the compensator 375 reduces the compensation signal Scm so that the intensity of the light output can be decreased through decreasing the duty cycle of the PWM signal S_{PWM} by the PWM signal generator 380.

In another embodiment, the first and second input ends of the comparator 381 are the negative and positive input ends, and the duty cycle of the PWM signal S_{PWM} is increasing following the decrease of the compensation signal Scm. That is, if the feedback signal is less than the reference signal Sref, the compensator 375 decreases the compensation signal Scm so that the intensity of the light output can be increased through increasing the duty cycle of the PWM signal S_{PWM} by the PWM signal generator 380. Alternatively, if the feedback signal is greater than the reference signal Sref, the compensator 375 increases the compensation signal Scm so that the intensity of the light output can be decreased through decreasing the duty cycle of the PWM signal S_{PWM} by the PWM signal generator 380.

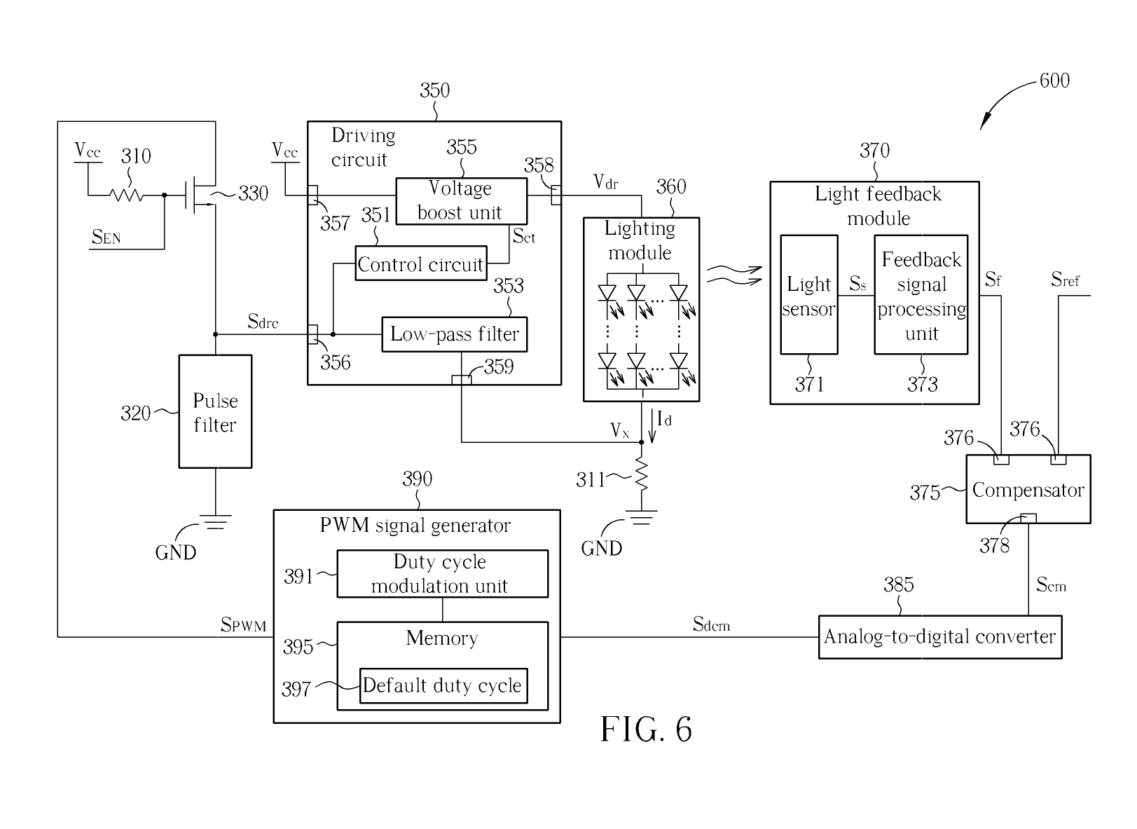

Please refer to FIG. 6, which is a schematic diagram showing a lighting system 600 having control architecture in accordance with a third embodiment of the present invention. As shown in FIG. 6, the lighting system 600 comprises a switch 330, a first resistor 310, a pulse filter 320, a driving circuit 350, a lighting module 360, a second resistor 311, a light feedback module 370, a compensator 375, an analog-to-digital converter 385 and a PWM signal generator 380. The coupling relationships and related functionalities regarding the switch 330, the first resistor 310, the pulse filter 320, the driving circuit 350, the lighting module 360, the second resistor 311, the light feedback module 370, and the compensator 375 are similar to the above description on the lighting systems 300 and 500. Consequently, in the operation of the lighting system 600, the truth table of the enable control signal S_{EN}, the PWM signal S_{PWM} and the driving control signal Sdrc is still the same as the truth table 400 in FIG. 4. The analog-to-digital converter 385 is coupled between the compensator 375 and the PWM signal generator 390 and functions to convert the compensation signal Scm into a digital compensation signal Sdcm.

The PWM signal generator 390 is substantially a digital signal processor for generating the PWM signal S_{PWM} based on the digital compensation signal Sdcm. The PWM signal generator 390 comprises a duty cycle modulation unit 391 and a memory 395. The memory 395 is utilized for storing a default duty cycle 397. The memory 395 can be an electrically erasable programmable read only memory or a flash memory. The duty cycle modulation unit 391 regulates the duty cycle of the PWM signal S_{PWM} based on the digital compensation signal Sdcm. When the lighting system 600 is initially powered, the duty cycle modulation unit 391 may set the initial duty cycle of the PWM signal S_{PWM} to be the default duty cycle 397 stored in the memory 395.

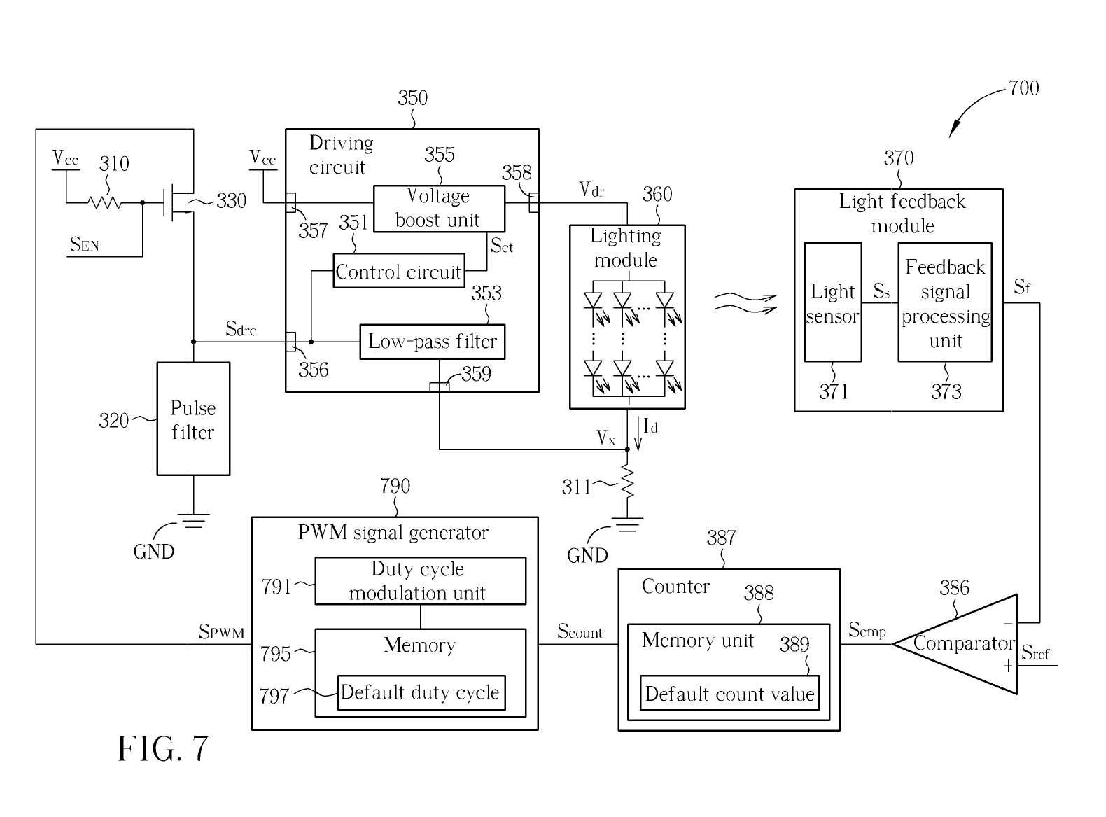

Please refer to FIG. 7, which is a schematic diagram showing a lighting system 700 having control architecture in accordance with a fourth embodiment of the present invention. As shown in FIG. 7, the lighting system 700 comprises a switch 330, a first resistor 310, a pulse filter 320, a driving circuit 350, a lighting module 360, a second resistor 311, a light feedback module 370, a comparator 386, a counter 387, and a PWM signal generator 790. The coupling relationships and related functionalities regarding the switch 330, the first resistor 310, the pulse filter 320, the driving circuit 350, the lighting module 360, the second resistor 311, and the light feedback module 370 are similar to the above description on the lighting systems 300 and 500. Consequently, in the operation of the lighting system 700, the truth table of the enable control signal S_{EN}, the PWM signal S_{PWM} and the driving control signal Sdrc is also the same as the truth table 400 in FIG. 4.

The comparator 386 can be an operational amplifier 386 for generating a compare signal Scmp by comparing the feedback signal Sf with the reference signal Sref. The comparator 386 comprises a first input end coupled to the light feedback module 370 for receiving the feedback signal Sf, a second input end for receiving the reference signal Sref, and an output end for outputting the compare signal Scmp. In the embodiment shown in FIG. 7, the first and second input ends of the comparator 386 are the negative and positive input ends. If the reference signal Sref is greater than the feedback signal Sf, the comparator 386 outputs the compare signal Scmp with high voltage level. On the contrary, if the reference signal Sref is less than the feedback signal Sf, the comparator 386 outputs the compare signal Scmp with low voltage level.

The counter 387 is coupled between the comparator 386 and the PWM signal generator 790. The counter 387 functions to generate a count signal Scount by performing an up-counting process or a down-counting process based on the compare signal Scmp. The counter 387 comprises a memory unit 388 for storing a default count value 389. The memory unit 388 can be an electrically erasable programmable read only memory or a flash memory. When the lighting system 700 is initially powered, the counter 387 may set the initial count value of the count signal Scount to be the default count value 389 stored in the memory unit 388. The PWM signal generator 790 comprises a duty cycle modulation unit 791 and a memory 795. The memory 795 is utilized for storing a default duty cycle 797. The memory 795 can be an electrically erasable programmable read only memory or a flash memory. The duty cycle modulation unit 791 regulates the duty cycle of the PWM signal S_{PWM} based on the count signal Scount. When the lighting system 700 is initially powered, the duty cycle modulation unit 791 may set the initial duty cycle of the PWM signal S_{PWM} to be the default duty cycle 797 stored in the memory 795. In another embodiment, the memory 795 can be omitted, and the duty cycle modulation unit 791 may set the initial duty cycle of the PWM signal SPWM based on the count signal Scount having the default count value 389 when the lighting system 700 is initially powered.

In the feedback operation of the lighting system 700, if the intensity of the light output is lower than a desired intensity, then the feedback signal Sf is less than the reference signal Sref, and the comparator 386 outputs the compare signal Scmp with high voltage level so that the counter 387 is driven to perform an up-counting process for raising the count signal Scount. Accordingly, the duty cycle of the PWM signal S_{PWM} is increased for enhancing the light output of the lighting module 360 following the increase of the count signal Scount. Alternatively, if the intensity of the light output is higher than the desired intensity, then the feedback signal Sf is greater than the reference signal Sref, and the comparator 386 outputs the compare signal Scmp with low voltage level so that the counter 387 is driven to perform a down-counting process for lowering the count signal Scount. Accordingly, the duty cycle of the PWM signal S_{PWM} is decreased for reducing the light output of the lighting module 360 following the decrease of the count signal Scount.

To sum up, in the operation of the lighting system of the present invention, regardless of an open-loop control or a feedback control, the quasi low-level signal will not occur to the driving control signal, and furthermore the periodical pulse noise regarding the driving control signal is filtered out. Accordingly, the lighting system of the present is capable of providing an accurate control of the light output by completely solving the problem of redundant lighting.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A lighting system having control architecture, the lighting system comprising:
a switch comprising:
a first end for receiving a pulse width modulation (PWM) signal;
a control end for receiving an enable control signal; and
a second end for outputting a driving control signal;
a first resistor comprising:
a first end for receiving a supply voltage; and
a second end coupled to the control end of the switch;
a pulse filter comprising:
a first end coupled to the second end of the switch; and
a second end coupled to a ground; and
a lighting module coupled between the second end of the switch and the ground, the lighting module being utilized for generating a light output based on the driving control signal.

2. The lighting system of claim 1, further comprising:
a second resistor comprising:
a first end coupled to the lighting module; and
a second end coupled to the ground.

3. The lighting system of claim 2, further comprising:
a driving circuit for generating a driving voltage based on the supply voltage and the driving control signal, and for generating a driving current control voltage based on the driving control signal, the driving circuit comprising:
a power end for receiving the supply voltage;
an input end coupled to the second end of the switch for receiving the driving control signal;
a first output end coupled to the lighting module for outputting the driving voltage; and
a second output end coupled to the first end of the second resistor for outputting the driving current control voltage.

4. The lighting system of claim 3, wherein the driving circuit further comprises:
a voltage boost unit coupled to the power end, the input end and the first output end of the driving circuit, the voltage boost unit being utilized for generating the driving voltage by performing a voltage boosting operation on the supply voltage according to the driving control signal; and
a low-pass filter coupled between the input end and the second output end of the driving circuit, the low-pass filter being utilized for generating the driving current control voltage by performing a low-pass filtering operation on the driving control signal.

5. The lighting system of claim 4, wherein the driving circuit further comprises:
a control circuit coupled between the input end and the voltage boost unit of the driving circuit, the control circuit being utilized for generating a control signal by compensating the driving control signal with a turn-on voltage drop of the switch;
wherein the voltage boost unit generates the driving voltage by performing the voltage boosting operation on the supply voltage according to the control signal.

6. The lighting system of claim 1, wherein the switch is a metal oxide semiconductor field effect transistor or a junction field effect transistor.

7. The lighting system of claim 1, wherein the pulse filter is a varistor, a transient voltage suppressor, or a high-pass filter.

8. The lighting system of claim 7, wherein the high-pass filter is a capacitor.

9. The lighting system of claim 1, wherein the lighting module is an LED module having an LED unit or a plurality of parallel-connected LED units, each LED unit comprising an LED or a plurality of series-connected LEDs.

10. The lighting system of claim 1, further comprising a light feedback module for generating a feedback signal based on the light output of the lighting module, the light feedback module comprising:
a light sensor for generating a light sensing signal by detecting the light output of the lighting module; and
a feedback signal processing unit for generating the feedback signal based on the light sensing signal.

11. The lighting system of claim 10, further comprising:
a compensator for generating a compensation signal based on the feedback signal and a reference signal, the compensator comprising:
a first input end coupled to the light feedback module for receiving the feedback signal;
a second input end for receiving the reference signal; and
an output end for outputting the compensation signal.

12. The lighting system of claim 11, further comprising:
a PWM signal generator coupled between the compensator and the first end of the switch, the PWM signal generator being utilized for generating the PWM signal based on the compensation signal, the PWM signal generator comprising:
a ramp-wave signal generator for generating a ramp-wave signal, the ramp-wave signal being a triangular-wave signal or a sawtooth-wave signal; and
a comparator comprising:
a first input end coupled to the output end of the compensator for receiving the compensation signal;
a second input end coupled to the ramp-wave signal generator for receiving the ramp-wave signal; and
an output end coupled to the first end of the switch for outputting the PWM signal.

13. The lighting system of claim 12, wherein the first input end of the comparator is a positive input end or a negative input end.

14. The lighting system of claim 11, further comprising:
an analog-to-digital converter coupled to the compensator for receiving the compensation signal, the analog-to-digital converter being utilized for converting the compensation signal into a digital compensation signal.

15. The lighting system of claim 14, further comprising:
a PWM signal generator coupled between the analog-to-digital converter and the first end of the switch, the PWM signal generator being utilized for generating the PWM signal based on the digital compensation signal, the PWM signal generator comprising:
a duty cycle modulation unit for regulating a duty cycle of the PWM signal based on the digital compensation signal.

16. The lighting system of claim 15, wherein the PWM signal generator further comprises:
a memory for storing a default duty cycle, the default duty cycle being used as an initial duty cycle of the PWM signal.

17. The lighting system of claim 10, further comprising:
a comparator comprising:
a first input end coupled to the light feedback module for receiving the feedback signal; <a second input end for receiving a reference signal; and <an output end for outputting a compare signal;
a counter coupled to the output end of the comparator, the counter being utilized for generating a count signal by performing an up-counting process or a down-counting process based on the compare signal; and
a PWM signal generator coupled to the counter, the PWM signal generator being utilized for generating the PWM signal based on the count signal.

18. The lighting system of claim 17, wherein the counter comprises:
a memory unit for storing a default count value, the default count value being used as an initial count value of the count signal.

19. The lighting system of claim 17, wherein the PWM signal generator comprises:
a duty cycle modulation unit for regulating a duty cycle of the PWM signal based on the count signal.

20. The lighting system of claim 19, wherein the PWM signal generator further comprises:
a memory for storing a default duty cycle, the default duty cycle being used as an initial duty cycle of the PWM signal.
